(19) United States
(12) Patent Application Publication
(10) Pub. No.: US 2021/0209250 A1
(43) Pub. Date: Jul. 8, 2021

(54) SYSTEM AND METHOD FOR MANAGING OF PERSONALLY IDENTIFIABLE INFORMATION

(71) Applicant: ENZUZO INC., Waterloo (CA)

(72) Inventors: Mate PRGIN, Waterloo (CA); Tim TSAI, Waterloo (CA)

(21) Appl. No.: 17/143,642

(22) Filed: Jan. 7, 2021

Related U.S. Application Data
(60) Provisional application No. 62/957,867, filed on Jan. 7, 2020.

(51) Int. Cl. G06F 21/62; G06F 21/60

(52) U.S. Cl. CPC G06F 21/6254; G06F 21/602

(57) ABSTRACT

A method for managing personally identifiable information including: monitoring for at least one user requests and user records; determining whether a change to personally identifiable information is created based on the user requests and records; determining whether the change is authorized; if the change is authorized, continuing to monitor for user requests and user records; and if the change is not authorized, taking action to remove the personally identifiable information. A system for managing personally identifiable including: at least one computing device configured with processors and memory, the memory including instructions that, upon execution, cause the system to: monitor for at least one user requests and user records; determine whether a change to personally identifiable information is created based on the user requests and records; determine whether the change is authorized; and if the change is not authorized, take action to remove the personally identifiable information.

### RELATED APPLICATIONS

The present disclosure claims priority to U.S. Provisional Patent Application No. 62/957,867 filed Jan. 7, 20202 which is hereby incorporated in its entirety by reference.

### FIELD

The present disclosure relates generally to personal information stored in a computer system. More particularly, the present disclosure relates to a system and method for managing personally identifiable information on a computer network.

### BACKGROUND

In an increasingly digital world, consumers and end users are starting to understand the impact of companies having their personal data and are demanding the right to their data and privacy. Existing and new legislations such as the European Union's General Data Protection Regulation (GDPR) and California Consumer Privacy Act (CCPA) aim to address these concerns but do not prescribe how they are to be addressed. Many companies have resorted to manual processes which may be error prone, and ultimately non-compliant processes.

As such, it is beneficial to have an improved method and system to monitor personal information and data.

The above information is presented as general background information only to assist with an understanding of the present disclosure. No determination has been made, and no assertion is made, as to whether any of the above might be applicable as prior art with regard to the present disclosure.

### SUMMARY

In a first aspect, there is provided a method for managing personally identifiable information in a computer system; the method including: monitoring for at least one user requests and user records; determining whether a change to personally identifiable information is created based on the user requests and records; determining whether the change is authorized; if the change is authorized, continuing to monitor for user requests and user records; and if the change is not authorized, taking action to remove the personally identifiable information.

In some cases, taking action to remove the personally identifiable information may include notifying at least one administrator or associated user of the personally identifiable information.

In some cases, taking action to remove the personally identifiable information may include deleting the at least one user record.

In some cases, taking action to remove the personally identifiable information may include providing a deletion request on behalf of a user associated with the personally identifiable information.

In some cases, determining whether the change to personally identifiable information is created may include: determining an encrypted or hash associated with each personally identifiable information on a per user basis; and determining if there is a change in the encrypted or hashed information from previously stored personally identifiable information.

In some cases, determining whether the change is authorized may include determining whether the user is associated with any predetermined conditions.

In some cases, determining whether the user is associated with the predetermined conditions may include determining if the user is associated with a whitelist, a watch list or a blacklist.

In some cases, the whitelist may include users who have expressly given consent to store personally identifiable information.

In some cases, the watch list may include users who are to be notified of any change in any previously stored personally identifiable information.

In some cases, the blacklist may include users who are not to have any stored personally identifiable information.

In another aspect, there is provided a system for managing personally identifiable information in a computer system; the system including: at least one computing device configured with processors and memory, the memory including instructions that, upon execution, cause the system to: monitor for at least one user requests and user records; determine whether a change to personally identifiable information is created based on the user requests and records; determine whether the change is authorized; if the change is authorized, continue to monitor for user requests and user records; and if the change is not authorized, take action to remove the personally identifiable information.

In some cases, the system may be configured to take action to remove the personally identifiable information by notifying at least one administrator or associated user of the personally identifiable information.

In some cases, the system may be configured to take action to remove the personally identifiable information by deleting the at least one user record.

In some cases, the system may be configured to take action to remove the personally identifiable information by providing a deletion request on behalf of a user associated with the personally identifiable information.

In some cases, the system may be configured to determine whether the change to personally identifiable information is created by: determining an encrypted or hash associated with each personally identifiable information on a per user basis; and determining if there is a change in the encrypted or hashed information from previously stored personally identifiable information.

In some cases, the system may be configured to determine whether the change is authorized by determining whether the user is associated with any predetermined conditions.

In some cases, determining whether the user is associated with the predetermined conditions may include determining if the user is associated with a whitelist, a watch list or a blacklist.

In some cases, the whitelist may include users who have expressly given consent to store personally identifiable information.

In some cases, the watch list may include users who are to be notified of any change in any previously stored personally identifiable information.

In some cases, the blacklist may include users who are not to have any stored personally identifiable information.

Other aspects and features of the present disclosure will become apparent to those ordinarily skilled in the art upon review of the following description of specific embodiments in conjunction with the accompanying figures.

### BRIEF DESCRIPTION OF FIGURES

Embodiments of the present disclosure will now be described, by way of example only, with reference to the attached Figures.

FIG. 1 illustrates a system architecture and the interaction between the system and external components;

FIG. 2 illustrates a method for delete and information monitoring according to an embodiment; and

FIG. 3 illustrates a system for managing personal information according to an embodiment.

### DETAILED DESCRIPTION

Generally, the present disclosure provides a method and system for a software as a service (SaaS) solution, which integrates into a company's computer systems and databases, anywhere that may contain or store Personally Identifiable Information (PII), via Application Programming Interface (API). The system and method are intended to continuously monitor any connected solution to ensure deleted or otherwise blacklisted records never re-enter any software, system or database. The embodiments of system and method are intended to ensure that PII data is only communicated and stored in hashed (non-reversible) or in some type of encrypted forms such that non-authorized parties cannot access the PII data, even in the event of a data breach.

PII data is considered to be any data that can be used to identify a specific individual. Conventionally, full personal names, Social Security numbers, mailing or email address, and phone numbers have most commonly been considered PII. More recently, the scope of PII has expanded and can include more technological based data such as, an IP address, login IDs, social media posts, or digital images, geolocation, biometric, behavioral data and the like. However, any data or combination of data that allows identification of a specific individual can be included in the definition.

The embodiments of the system and method may also include a web portal, where a user (customer, employee, prospect, or the like) can be authenticated and asked for their information to be reviewed and/or deleted. The system may generate a black list on behalf of the user, which is to be monitored to ensure that the user's personal information does not appear in a specific system again. A conventional challenge is, once PII has been deleted or requested to be monitored and continuous monitoring needs to start (i.e. on a black list or the like), the system is not allowed to store or otherwise have a copy of that PII any more (as required under at least some laws (GDPR, CCPA)). Therefore embodiments of the present system and method provide for a unique identifier, such as an email address which may be hashed or encrypted, and that hashed or encrypted identifier may be used to monitor to make sure that record is never re-inserted. If a previously deleted and wrongfully re-inserted record is found, an alert may be sent to the administrator of the solution to rectify the problem, or the system may automatically take action with respect to the record. A unique identifier can also be made up of multiple identifiers, which taken together as a group or by mathematical combination or the like, can uniquely identify a user.

Conventional systems tend to store email and other PII information in plaintext or only somewhat encrypted. In the case of a data breach, the plaintext is readily leveraged by an attacker. Even if the data is encrypted, if the attacker was able to recover a key, the whole database is compromised. Because the system and method detailed herein hashes or encrypts each PII information on a more granular basis (for example, a per user or per company basis), user information cannot be recovered or can only be recovered if the granular information is compromised (i.e. on a per user or per company basis), even in the event of system breach.

In some cases, embodiments of the system may also allow a record to re-enter the system by an explicit whitelist or flag. In addition, as new people or companies are added, a user can request to be added to a watch list and be notified of additional PII information that is present and new requests can be added. Finally, a full compliance report can be generated of all transactions and activities to satisfy the regulatory requirements under regulations such as GDPR or CCPA. Embodiments of the system and method detailed herein are intended to ensure that the full lifecycle of a request, from the creation of the users and requests to the processing and the notifications are traceable and verifiable by the end user, the company, and can be independently validated.

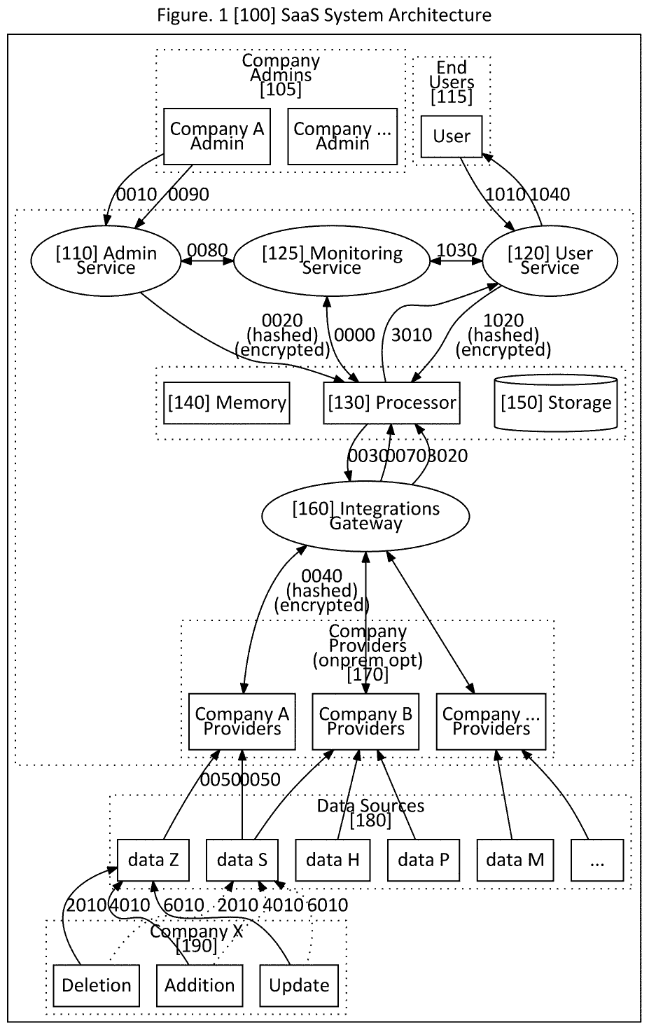

FIG. 1 illustrates a system 100 for managing personally identifiable information and the interactions with third parties. In particular, company administrators (admins) 105 may access an admin service 110 to review possible operations and additions of PII for the particular admin. End users 115 may access user services 120 to create, review, and manage their requests including being added to a blacklist, a whitelist, or a watch list.

The monitoring service 125 monitors the state of the system 100 and acts upon any changes, such as a periodic timer expiring, requests had changed, or user information has been updated in the system. The monitoring service 125 may continuously monitor the system 100 or may monitor certain aspects at predetermined intervals. The Integrations Gateway 160 is configured to provide an interface and aggregation between the system and the external customers' information using, for example, company providers 170. Each company provider 170 is configured to read, review and delete information from a plurality of data sources 180. Each data source may originate from a company such as Company X 190, or the like.

The system 100 is further configured to include at least one processor 130, at least one memory component 140, and a storage component 150. These components are intended to provide processing capability, temporary and persistent data storage for all the services, including requests, notifications, workflows, and any other system information/states.

Conventional systems, in the case of delete monitoring, tend to focus on an initial deletion of the user's information but conventional solutions do not tend to put in place a mechanism for continuous monitoring of the system to ensure that the user's information does not re-enter the system. In the case of information monitoring, conventional systems only focus on the initial request of the user's information but do not put in place a mechanism for continuous monitoring of the system so that the user may be notified of changes, or new instances of their information entering the system.

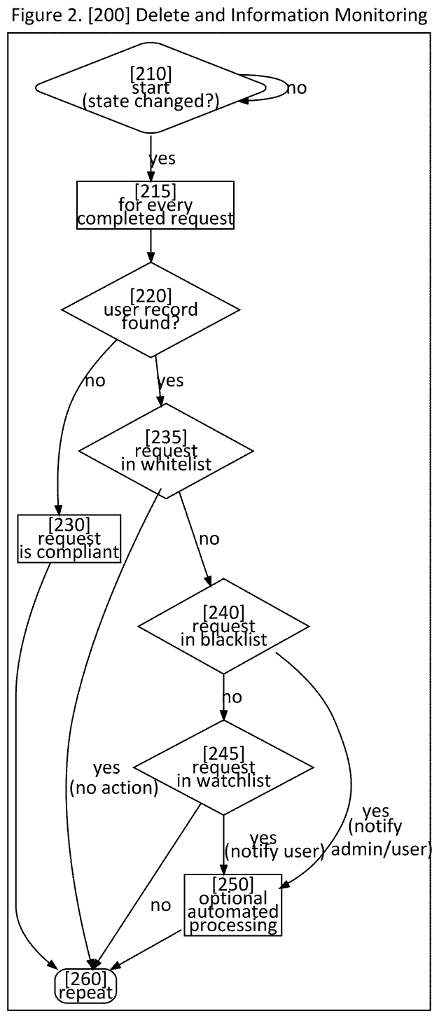

FIG. 2 illustrates a method 200 for delete and information managing according to an embodiment. The monitoring service 125, continuously monitors, at 210, each type of conditions by checking the state of the system against the list of conditions/rules and acts on each condition or rule if the condition is satisfied. As the monitoring service monitors, it reviews every completed request at 215. Reviewing the completed request, the monitoring service may determine whether a user record is found, at 220.

The monitoring service may determine that a user record is found and may then review the conditions associated with the user request. If the user request is a whitelist match, at 235, the monitoring service will determine that the user has provided explicit consent to the storage of the personal information. The monitoring service 125 will determine that no action is required and will continue to monitor the stored information, at 260.

The monitoring service 125 may determine the condition is a blacklist match at 240. A match for an existing request to a record in the blacklist may indicate the company has become non-compliant to legislation due to data being inserted back into the system after a deletion request. If the request is on the blacklist, an administrator may be notified and further automated processing, at 250, may be completed, for example, removing the record, and then continuing to monitor, at 260.

If the record is not on the blacklist or whitelist, the monitoring service may determine whether the user is listed on a watch list, at 245. For the watch list, the user has requested to be notified if any new personal information associated with the user is entered and stored by the system. If the system determines the user is on the watch list, the system may notify the user of the additional information and may perform other automated processing that may have been requested by the user or determined by the system, at 250. The system may then continue to monitor the system at 260.

Other conditions may be included by the system and may be defined within the workflow, depending on the type of personally identifiable information being reviewed and monitored by the system.

Generally, the monitoring service is configured to continuously monitor for changes in requests, Admin and user data. In some cases, where data change notifications are unavailable, the monitoring service may query the data sources at predefined intervals to detect changes. The predefined intervals may be, for example, every second, every minute, every hour, every day or longer. In some cases, the predefined intervals may be based on business requirements.

The monitoring service may also be configured to detect whether previously compliant deleted requests are now out of compliance. This may occur, for example, if user data was inadvertently added back to a company database, or if a user enabled monitoring service and new information about that user has entered the system. In some cases, the admin and user may both be notified by the system on a status change, or the system may perform an automated action on the information. For example, if a user's information is added, the user can be notified that new PII information has been found, or a request can automatically be submitted on behalf of the user based on, for example, user and company preferences/policies. In some cases, the action may be dependent on the type of PII that was retrieved or determined by the system.

Specifically, in a particular example, an embodiment of the system may be configured to execute the method for managing personally identifiable information as follows. To determine a state change, the processor may be configured to load requests, rules, and user records from a memory component and/or a storage component.

The processor can be configured to determine if any new requests or user record have entered the system. For every new request, the processor compares the PII information on the request with the user records database to determine a match, using, for example, hashed or encrypted email or the like. For every new user record, the processor compares the PII information with any existing requests to determine whether there is a match. If any condition is true, the system state has changed and further processing may be required.

The system may enter the next state on a condition change, and for every completed request (requests where the status is completed), the system is configured to check if any user PII information exists in the system or is saved in storage. Typically this check may be completed by determining whether the user's email address matches. The user's email address may potentially be in encrypted or hash form. In some cases, other information may be used as well, including, for example, phone number, addresses, name, or a combination thereof.

For any given request, if the user originating the request is NOT found in the system (for example, by the absence of a match in the PII), the monitoring service considers the request compliant and no further action is required. For any given request, if the user originating the request is found in the system (for example, by a match in the PII), but the user has previously consented to be in the system (which may be determined by the user being listed on the whitelist), no further action is required.

For any given request, if the user originating the request is found in the system for the company (for example, by a match in the PII for that company), and the user has previously requested that their information should be deleted for that company (which may be determined by the user being listed on the blacklist), the request may now be considered non-compliant. The system is intended to notify the administrator and/or the user of this change and optionally, the user information can automatically be deleted, the user record can be deleted, or opt-out via automated processing by the system, for example, by an automated deletion request.

For any given request, if the user originating the request is found in the system and the user has previously requested information monitoring, for example, the user who wish to be notified of any changes or the user is listed in a watch list, the system is configured to notify the user of this change. In some cases, the user information may be automatically processed by the system.

If a user's information matches a blacklist or a watch list, additional actions can be triggered. In one example, for a blacklist, the user's record can automatically be deleted or a deletion request or opt-out may again be selected as the user has already previously requested this action, making the original request compliant again. In a further example, for a watch list, the system can automatically submit an information request on the user's behalf to the company.

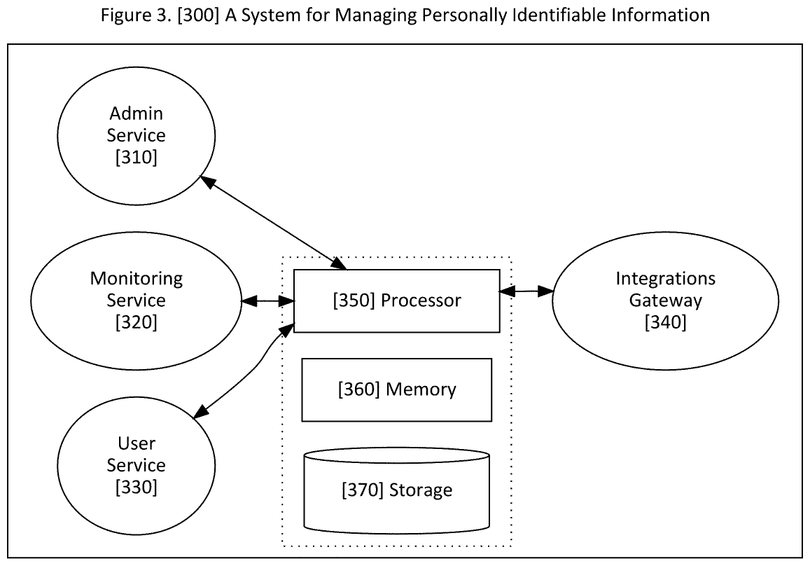

FIG. 3 illustrates an embodiment of a system 300 for managing personally identifiable information. The system includes an Admin service module 310, a monitoring service module 320, a user service module 330, an integration service module 340, at least one processor 350 and at least one memory component, shown here as memory 360, and a storage database 370. For example, the modules, including the processor 350 and memory 360, are in communication with each other but may be distributed over various network devices or may be housed within a single network device.

The Admin service module 310 is configured to allow company administrators to interface with the system and process user requests. The user service module 330 is configured to allow end users to interface with the system and submit requests and setup preferences. The monitoring service module 320 is configured to continuously monitor for changes and triggers actions based on those changes as detailed herein. Finally, the integration gateway 340 interfaces with company data sources to detect, retrieve, and otherwise process company user records.

In a specific example, due to an operator error, some data was deleted from Company A's SalesForce™ database. An old version of the database was restored from backup. The system, via for example, the monitoring service module 320, is configured to detect a user's data in SalesForce wherein the user is associated with a completed deletion request. This is detected by the monitoring service module 320 by the presence of the user's record when checked against the blacklist. The system is intended to notify an administrator of the discrepancy. The administrator reviews the request, and quickly requests that the data be deleted again to remain in compliance. Optionally, the company can configure a policy to automatically delete the user to ensure compliance.

In another specific example, a user, Bob, was thoroughly impressed with his experience using the system that he signed up as a general user. As a privacy conscious user, Bob would like to know when his data appears in any data source. Using the system tool web portal, Bob provided consent to monitor his data on available data sources.

Bob recently registered as an interested voter to the Moose political party. Unbeknownst to him, Moose outsourced their marketing campaign and all the user's information ended up in the marketing database of AmWay™. As AmWay is a customer of the system, Bob's information was automatically detected and the system sent a notification to Bob.

Bob received a system notification that his information was detected in AmWay's database. As Bob likes AmWay, he decided to not request deletion for his information. He did notice that the system provides an option to Opt-Out of any marketing communications from AmWay. Bob chose to Opt-Out of marketing communications and the request was submitted to the system. AmWay received the Opt-Out request through the system and accepted the request, as Bob's identity was already verified through the system, via the user service and the integration gateway detailed herein.

Bob next decides that he no longer wishes to be added to any marketing information by default. Bob enters a request into the system, via the user services module, and specifies that for any new information detected about him, the system should automatically send an Opt-Out request on his behalf. From this point on, any time new information about Bob enters into the system, an Opt-Out is automatically submitted.

In the preceding description, for purposes of explanation, numerous details are set forth in order to provide a thorough understanding of the embodiments. However, it will be apparent to one skilled in the art that these specific details may not be required. It will also be understood that aspects of each embodiment may be used with other embodiments even if not specifically described therein. Further, some embodiments may include aspects that are not required for their operation but may be preferred in certain applications. In other instances, well-known structures may be shown in block diagram form in order not to obscure the understanding. For example, specific details are not provided as to whether the embodiments described herein are implemented as a software routine, hardware circuit, firmware, or a combination thereof.

Embodiments of the disclosure or elements thereof can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with other modules and elements, including circuitry or the like, to perform the described tasks.

The above-described embodiments are intended to be examples only. Alterations, modifications and variations can be effected to the particular embodiments by those of skill in the art without departing from the scope, which is defined solely by the claim appended hereto.

What is claimed is:

1. A method for managing personally identifiable information in a computer system; the method comprising:
monitoring for at least one user requests and user records;
determining whether a change to personally identifiable information is created based on the user requests and records;
determining whether the change is authorized;
if the change is authorized, continuing to monitor for user requests and user records; and
if the change is not authorized, taking action to remove the personally identifiable information.

2. The method according to claim 1, wherein taking action to remove the personally identifiable information comprises:
notifying at least one administrator or associated user of the personally identifiable information.

3. The method according to claim 1, wherein taking action to remove the personally identifiable information comprises:
deleting the at least one user request or user record.

4. The method according to claim 1, wherein taking action to remove the personally identifiable information comprises:
providing a deletion request on behalf of a user associated with the personally identifiable information.

5. The method of claim 1, wherein determining whether the change to personally identifiable information is created comprises:
determining an encrypted or hash associated with each personally identifiable information on a per user basis; and
determining if there is a change in the encrypted deletion or hashed information from previously stored personally identifiable information.

6. The method of claim 1, wherein determining whether the change is authorized comprises:
determining whether the user is associated with any predetermined conditions.

7. The method of claim 6, wherein determining whether the user is associated the predetermined conditions comprise determining if the user is associated with a whitelist, a watch list or a blacklist.

8. The method of claim 7, wherein the whitelist comprises users who have expressly given consent to store personally identifiable information.

9. The method of claim 7, wherein the watch list comprises users who are to be notified of any change in any previously stored personally identifiable information.

10. The method of claim 7, wherein the blacklist comprises users who are not to have any stored personally identifiable information.

11. A system for managing personally identifiable information in a computer system; the system comprising:
at least one computing device configured with processors and memory, the memory including instructions that, upon execution, cause the system to:
monitor for at least one user requests and user records;
determine whether a change to personally identifiable information is created based on the user requests and records;
determine whether the change is authorized;
if the change is authorized, continue to monitor for user requests and user records; and
if the change is not authorized, take action to remove the personally identifiable information.

12. The system of claim 11, wherein the system is configured to take action to remove the personally identifiable information by notifying at least one administrator or associated user of the personally identifiable information.

13. The system of claim 11, wherein the system is configured to take action to remove the personally identifiable information by deleting the at least one user record.

14. The system of claim 11, wherein the system is configured to take action to remove the personally identifiable information by providing a deletion request on behalf of a user associated with the personally identifiable information.

15. The system of claim 11, wherein the system is configured to determine whether the change to personally identifiable information is created by:
determining an encrypted or hash associated with each personally identifiable information on a per user basis; and
determining if there is a change in the encrypted or hashed information from previously stored personally identifiable information.

16. The system of claim 11, wherein the system is configured to determine whether the change is authorized comprises:
determining whether the user is associated with any predetermined conditions.

17. The system of claim 16, wherein determining whether the user is associated the predetermined conditions comprise determining if the user is associated with a whitelist, a watch list or a blacklist.

18. The system of claim 17, wherein the whitelist comprises users who have expressly given consent to store personally identifiable information.

19. The system of claim 17, wherein the watch list comprises users who are to be notified prior to any change in any previously stored personally identifiable information.

20. The system of claim 17, wherein the blacklist comprises users who are not to have any stored personally identifiable information.
